(19) United States
(12) Patent Application Publication
(10) Pub. No.: US 2011/0271211 A1
(43) Pub. Date: Nov. 3, 2011

(54) SYSTEMS, METHODS, AND COMPUTER PROGRAMS FOR CONTROLLING PRESENTATION VIEWS IN AN ONLINE CONFERENCE

(76) Inventors: BOLAND T. JONES, Atlanta, GA (US); David Michael Guthrie, Norcross, GA (US)

(21) Appl. No.: 13/078,099

(22) Filed: Apr. 1, 2011

Related U.S. Application Data
(63) Continuation-in-part of application No. PCT/US2010/033084, filed on Apr. 30, 2010.

(51) Int. Cl. G06F 3/00

(52) U.S. Cl. 715/753

(57) ABSTRACT

Various embodiments of systems, methods, and computer programs are disclosed for controlling presentation views in an online conference. One embodiment is a method for controlling presentation views in an online conference. One such method comprises: a conferencing system establishing an audio conference, via a communication network, between a plurality of participants; the conferencing system configuring a conference user interface to be presented to the plurality of participants via a corresponding client device in communication with the conference system via the communication network, the conference user interface having a participant view in which each of the plurality of participants are identified with a unique participant object having a graphical representation specified by the corresponding participant and a screen sharing view in which content presented in a first screen of a first client device associated with a first participant may be simultaneously presented in a second screen of a second client device associated with a second participant during a screen sharing session; and the conference user interface enabling the participants to selectively display one or more of the participant view and the screen sharing view during the screen sharing session.

### CROSS-REFERENCE TO RELATED APPLICATIONS

This application is a continuation-in-part patent application of International Patent Application Serial No. PCT/US2010/033084 entitled “Systems, Methods, and Computer Programs for Providing a Conference User Interface” and filed on Apr. 30, 2010, which is hereby incorporated by reference in its entirety.

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for controlling presentation views in an online conference. One embodiment is a method for controlling presentation views in an online conference. One such method comprises: a conferencing system establishing an audio conference, via a communication network, between a plurality of participants; the conferencing system configuring a conference user interface to be presented to the plurality of participants via a corresponding client device in communication with the conference system via the communication network, the conference user interface having a participant view in which each of the plurality of participants are identified with a unique participant object having a graphical representation specified by the corresponding participant and a screen sharing view in which content presented in a first screen of a first client device associated with a first participant may be simultaneously presented in a second screen of a second client device associated with a second participant during a screen sharing session; and the conference user interface enabling the participants to selectively display one or more of the participant view and the screen sharing view during the screen sharing session.

Another embodiment is a computer system comprising a conferencing system and a server. The conferencing system establishes an audio conference between a plurality of participants via a communication network. The server is configured to communicate with the conferencing system and the plurality of computing devices via the communication network. The server comprises a processor, a memory, and a view selector module stored in the memory and executed by the processor. The view selector module comprises: logic configured to present a conference user interface to the plurality of participants via a corresponding client device in communication with the server via the communication network, the conference user interface having a participant view in which each of the plurality of participants are identified with a unique participant object having a graphical representation of the corresponding participant and a screen sharing view in which a first screen of a first client device associated with a first participant may be shared with a second screen of a second client device associated with a second participant during a screen sharing session; and logic configured to enable the participants to selectively control presentation of one or more of the participant view and the screen sharing view during the screen sharing session.

### BRIEF DESCRIPTION OF THE DRAWINGS

FIG. 1 is a block diagram illustrating an embodiment of a computer system for controlling presentation views in an online conference between a participant view and a screen sharing view.

FIG. 2 is a screen shot of an embodiment of the conference user interface of FIG. 1 displaying the participant view.

FIG. 3 illustrates the conference user interface of FIG. 2 in which a sharing participant initiates a screen sharing session.

FIG. 4 is a screen shot illustrating an embodiment of a user interface displayed to viewing participant during the screen sharing session.

FIG. 5a is a screen shot illustrating another embodiment of a user interface displayed to the sharing participant during the screen sharing session.

FIG. 5b illustrates the screen shot of FIG. 5a in which the viewing participant selects a toggle view control.

FIG. 5c illustrates the participant view after the viewing participants selects the toggle view control.

FIG. 5d illustrates the screen shot of FIG. 5c in which the viewing participant selects the combined participant/screen share view control.

FIG. 5e is a screen shot illustrating an embodiment of a user interface for simultaneously displaying the participant view and the screen sharing view during the screen sharing session.

FIG. 6 is a flow chart illustrating the architecture, operation, and/or functionality of an embodiment of the participant/screen share view selector module(s) of FIG. 1.

### DETAILED DESCRIPTION

Various embodiments of systems, methods, and computer programs are disclosed for controlling presentation views (e.g., a participant view and/or a screen sharing view) displayed to participants of a conference via a conference user interface presented to a client device. The conference may comprise conferences, meetings, groupings or other types gatherings (collectively, a “conference” with a system that provides the conference user interface for a conference being referred to herein as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference, conference user interface, conferencing system, and related features may be implemented as described in the parent patent application, U.S. patent application Ser. No. 12/789,993, the entire contents of which are hereby incorporated by reference into this specification.

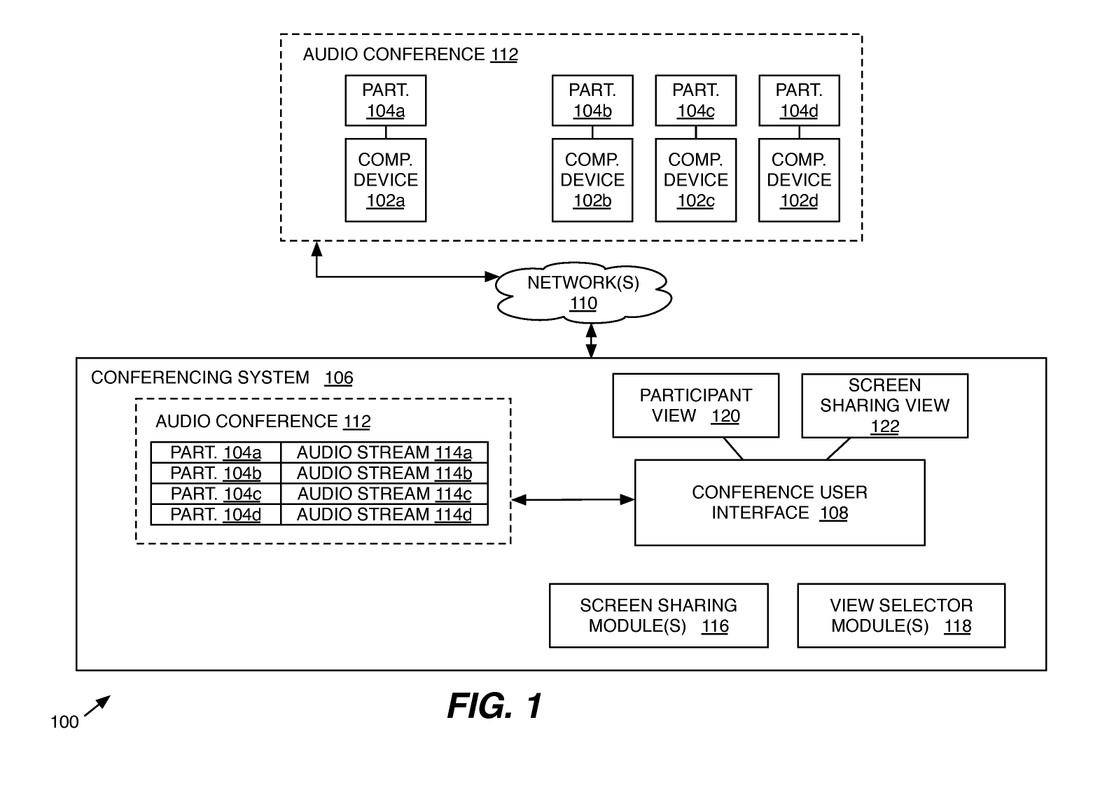

FIG. 1 illustrates a computer system 100 representing an exemplary working environment for enabling a participant in a conference (e.g., an audio conference 112) to selectively control user interface views displayed to a computing device. The computer system 100 comprises a plurality of computing devices 102 in communication with a conferencing system 106 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure. The computing devices 102 may be associated with participants 104a-104d, respectively, of an audio conference 112.

The computing devices 102 may comprise any desirable computing device, which is configured to communicate with the conferencing system 106 via the networks 110. The computing device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 106 via one or more networks 110. The computing device 102 may include a processor, a memory, a display device and software (e.g., a graphical user interface, an operating system, a browser, plug-in, or other applications) configured to provide various functions, including facilitating communication with the conferencing system 106. It should be appreciated that the hardware, software, and any other performance specifications of the computing device 102 are not critical and may be configured according to the particular context in which the computing device 102 is to be used.

The conferencing system 106 generally comprises a communication system for establishing an audio conference 112 between the computing devices 102. The audio conference 112 may have a corresponding online component presented to the computing devices 102a-102d via a conference user interface 108. As described below in more detail, the conference user interface 108 may be configured to enable the participants 104a-104d to selectively control one or more presentation views (e.g., a participant view 120 and a screen sharing view 122) to be displayed to the computing devices 102a-102d during the audio conference 112. In embodiment, the conference user interface 108 may be configured in any of the ways described in the above-referenced parent patent application, or others, to provide a visually engaging conference experience to the participants.

In general, the participant view 120 displays each of the plurality of participants 104 in the audio conference 112 with a unique participant object having a graphical representation identifying the corresponding participant. The screen sharing view 122 operates in association with a screen sharing application (e.g., screen sharing module(s) 116). The screen sharing application enables a first participant 104 (referred to as a “sharing participant”) to share content displayed on the first participant's computing device 102 with the other participants 104 (referred to as “viewing participants”) in the audio conference 112. The screen sharing application “shares” the content displayed on the first participant's computing device with the computing devices of the viewing participants. In the example illustrated in FIG. 1, the participant 104a is the sharing participant and the participants 104b, 104c, and 104d are the viewing participants. The screen sharing view 122 displays the content being shared by the sharing participants.

The conferencing system 106 may support audio via a voice network and/or a data network. In one of a number of possible embodiments, the conferencing system 106 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish an audio connection with the computing devices 102a-102d, although in some embodiments the audio portion may be removed. As illustrated in FIG. 1, the conferencing system 106 may establish the audio conference 112 by combining audio streams 114a-114d associated with the computing devices 102a-102d, respectively.

The conferencing system 106 comprises a processor, memory, and software for providing various functions, including the screen sharing module(s) 116 and the view selector module(s) 118. The view selector module(s) 118 generally comprise the logic or functionality for enabling the participants 104 to selectively control the presentation of the participant view 120 and the screen sharing view 122 in the conference user interface 108. One of ordinary skill in the art will appreciate that the screen sharing module(s) 116 and the view selector module(s) 118 (and any associated or other modules described herein) may be implemented in software, hardware, firmware, or a combination thereof. In one embodiment, the systems are implemented in software or firmware that is stored in a memory and that is executed by a suitable instruction execution system. In software or firmware embodiments, the logic may be written in any suitable computer language. In hardware embodiments, the systems may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

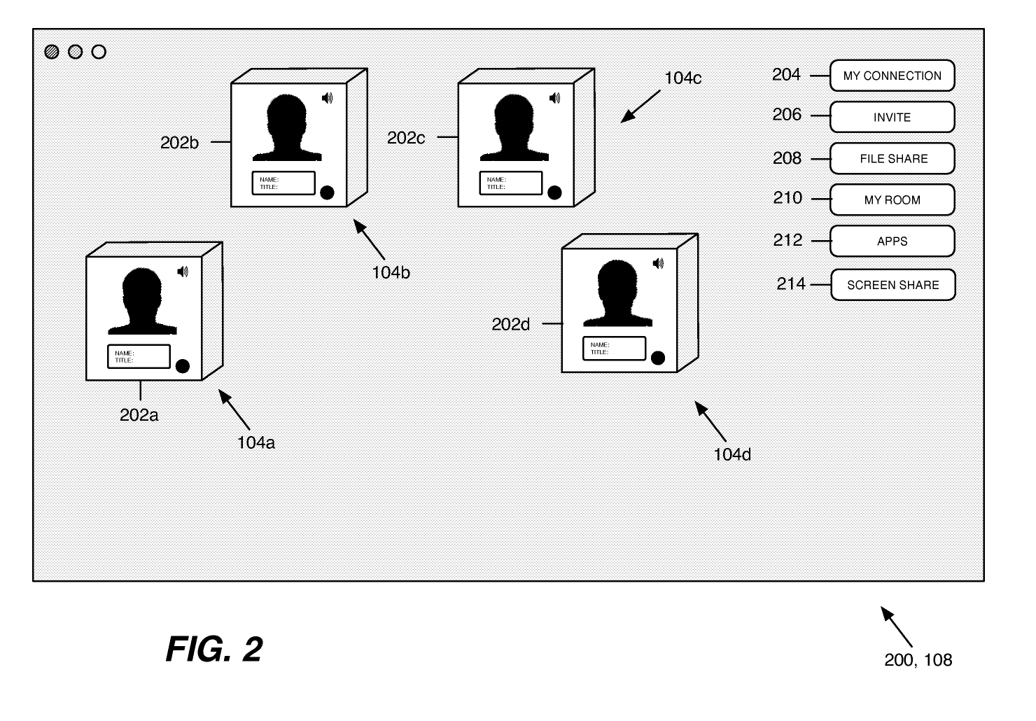

FIG. 2 illustrates an embodiment of the conference user interface 108 in which the participant view 120 is presented. In an embodiment, the participant view 120 graphically identifies each of the participants 104a-104d with, for example, a corresponding unique participant object 202. As described in the above-referenced parent patent application, the unique participant objects 202 may comprise a graphical representation identifying the participant, profile or contact information, an audio indicator, and other information about the participant. The graphical representation may comprise a picture, photograph, icon, avatar, etc. for identifying the corresponding participant 104.

In the embodiment of FIG. 2, the participant objects 202 comprise a cube having multiple display faces. When a participant 104 selects a user interface component, the cube may be expanded to display one or more faces of the object. The user selection may trigger the display of cube faces. Each face may display additional information about the participant. In an embodiment, the cube faces may be configurable by the participant and may display, for example, a social networking profile, updates to a social networking communication channel, video, graphics, images, or any other content. The cube faces may be further selected to return to the original collapsed cube. The participant objects 202 may be rotated (either automatically or via user selection) to display the respective cube faces. It should be appreciated that the participant objects 202 may be configured with additional or alternative visual effects and/or interactive functionality, as described in the above-referenced parent patent application.

As further illustrated in FIG. 2, the conference user interface 108 may comprise one or more selectable components for accessing various features of the conferencing system 106. A my connection component 204 may launch a display for enabling a participant 104 to configure the existing connection between the computing device 102 and the conferencing system 106. The participant 104 may disconnect a connection to the audio conference 112, establish a new connection to the audio conference 112 (e.g., by dial-out), or reconfigure the existing connection to the audio conference 112. In addition to configuring the audio connection, the participant 104 may also configure the connection to the online conference via the conference user interface 108. In an embodiment, the connection to the online conference may be transferred to another computing device 102 or another client on an existing computing device 102. This may enable the participant 104 to seamlessly maintain a presence in the online conference during the transfer.

An invite component 206 may launch a menu for enabling a participant 104 to invite additional participants 104 to the online conference. Additional participants may be invited by, for example, dialing out to a telephone number, sending an email including information for accessing the conferencing system 106, or sending a message to a web service, such as, for example, a social networking system.

A share component 208 may launch a menu for enabling a participant 104 to insert and share media with other participants in the online conference. A my room component 210 may launch a display for enabling a participant 104 to configure the appearance of the conference user interface 108. The participant 104 may configure the arrangement of the participant objects 202 or configure any other presentation parameter.

An apps component 212 may launch another menu for enabling a participant 104 to launch conference applications. As described in the above-referenced parent patent application, the conferencing system 106 may host a conference apps store for purchasing various conference applications. An app store component may launch the app store where the participant 104 may purchase conference applications. The my apps component may launch a display for enabling the participant 104 to select from applications that have already been purchased or are otherwise available to the participant 104. A host apps component may display conferencing applications that have been made available by the host of the online conference.

A screen share component 214 enables a sharing participant (i.e., participant 104a) to launch a screen sharing session during the conference. It should be appreciated that the screen sharing module(s) 116 may provide any desirable screen sharing features. In an embodiment, the screen sharing features enable the viewing participants 104b, 104c, and 104d to remotely view and/or control one or more aspects of the sharing participant's computing device 102.

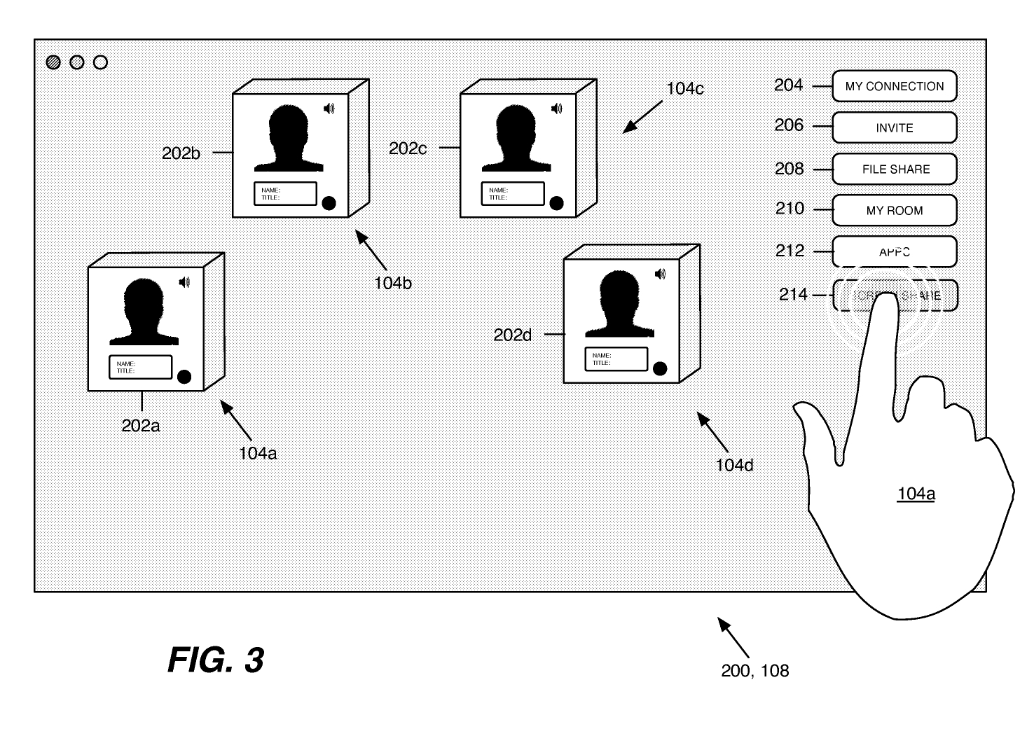

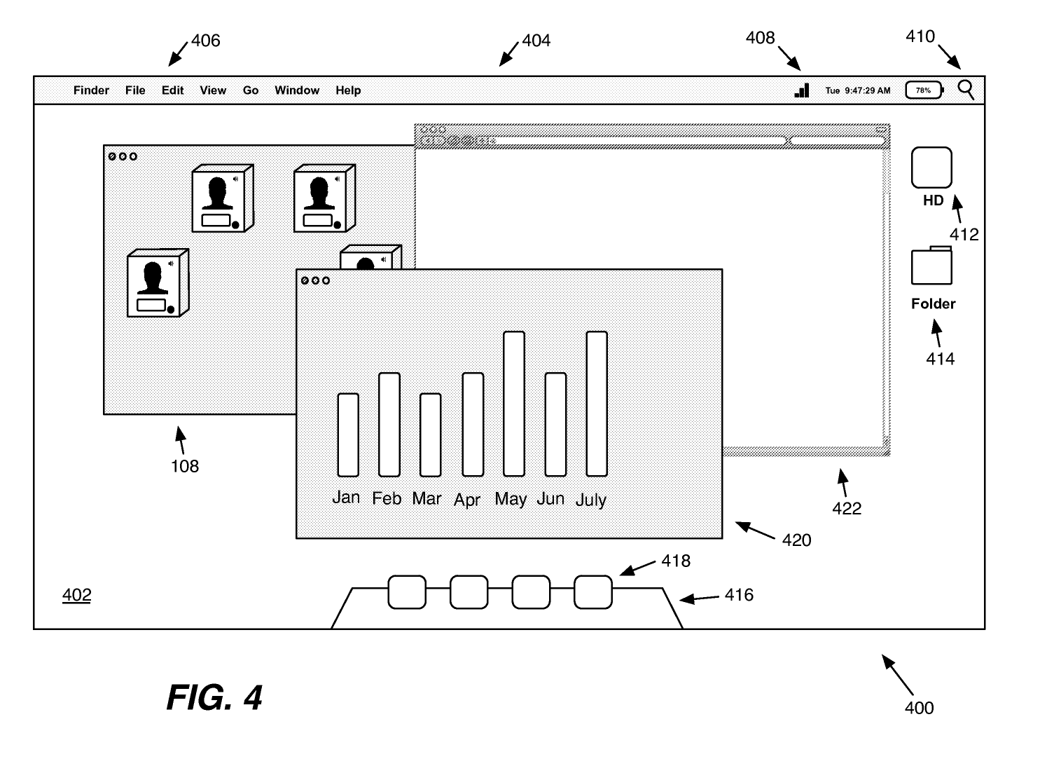

The sharing participant 104a may launch the screen sharing session by selecting the screen share component 214 (FIG. 2) or via any other suitable command. FIG. 3 illustrates an embodiment of the screen sharing view 122 displayed on a computing device 102. In this embodiment, the sharing participant 104a shares a desktop 400 (FIG. 4) associated with the computing device 102 by positioning an icon over and selecting the screen share component 214. The desktop 402 may display one or more icons (e.g., application icons 418 in a dock 416), wallpaper 402, widgets, or other desktop objects associated with the system. The desktop objects enable the user to easily access, configure, or modify aspects of the operating system and/or other software or features of the computing device 102. The desktop 400 may display a system taskbar 404 with additional icons for accessing various system features, such as, a menu 406, a search icon 410, a wireless networking icon 408, one or more folder icons 414 for organizing files, and a hard drive icon 412 for accessing a hierarchical folder structure for accessing files stored on the computing device 102.

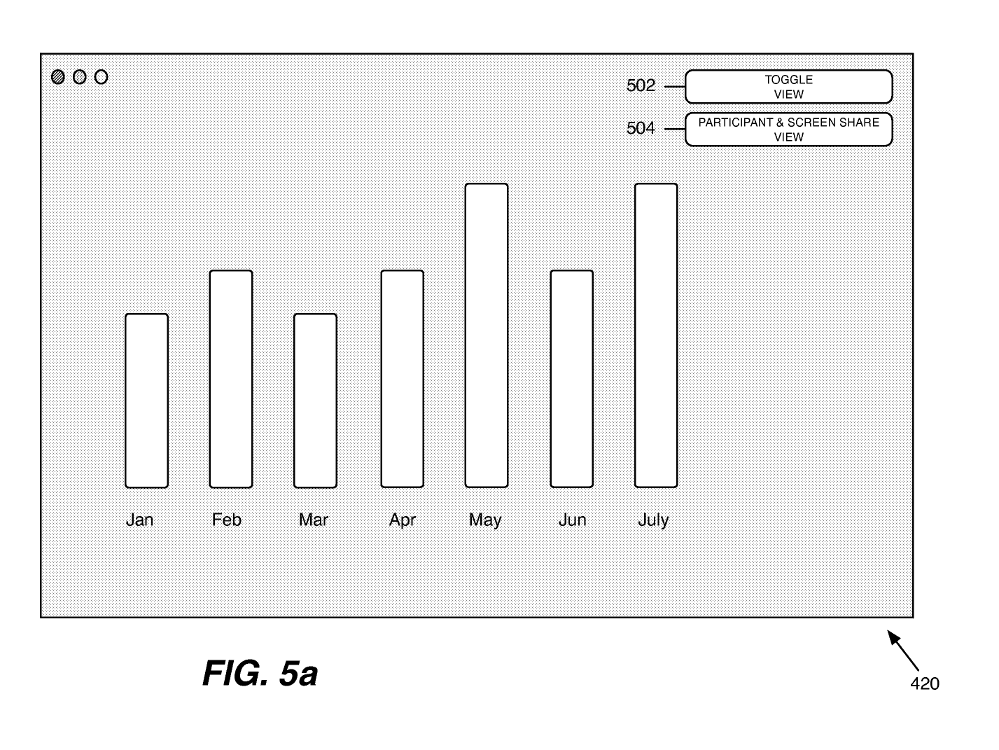

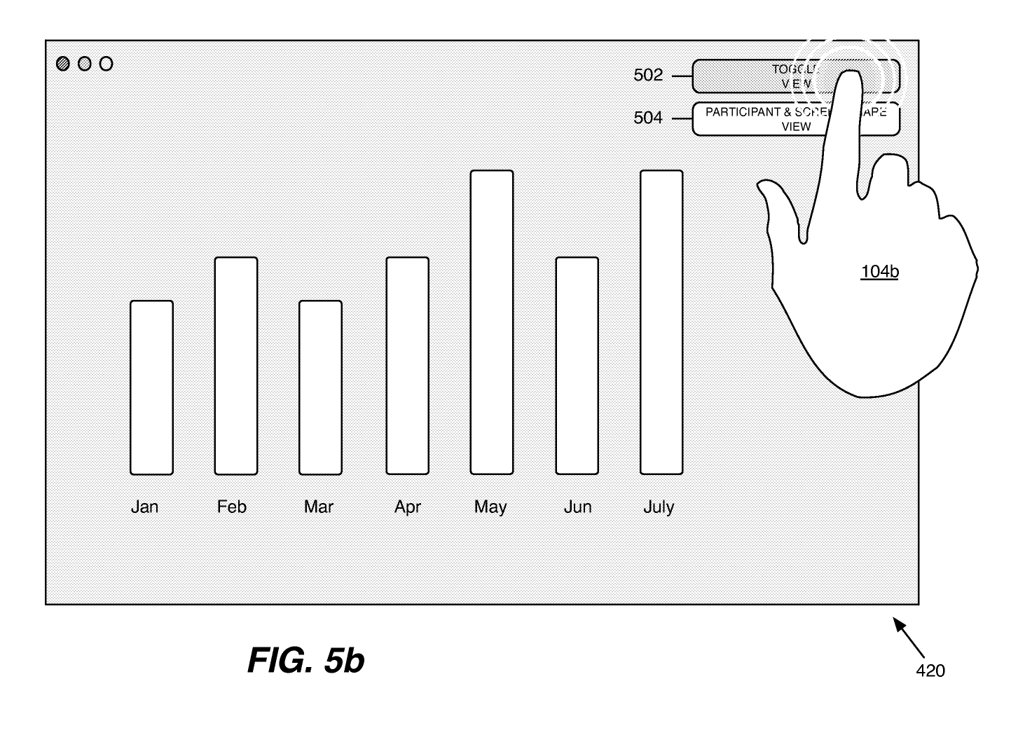

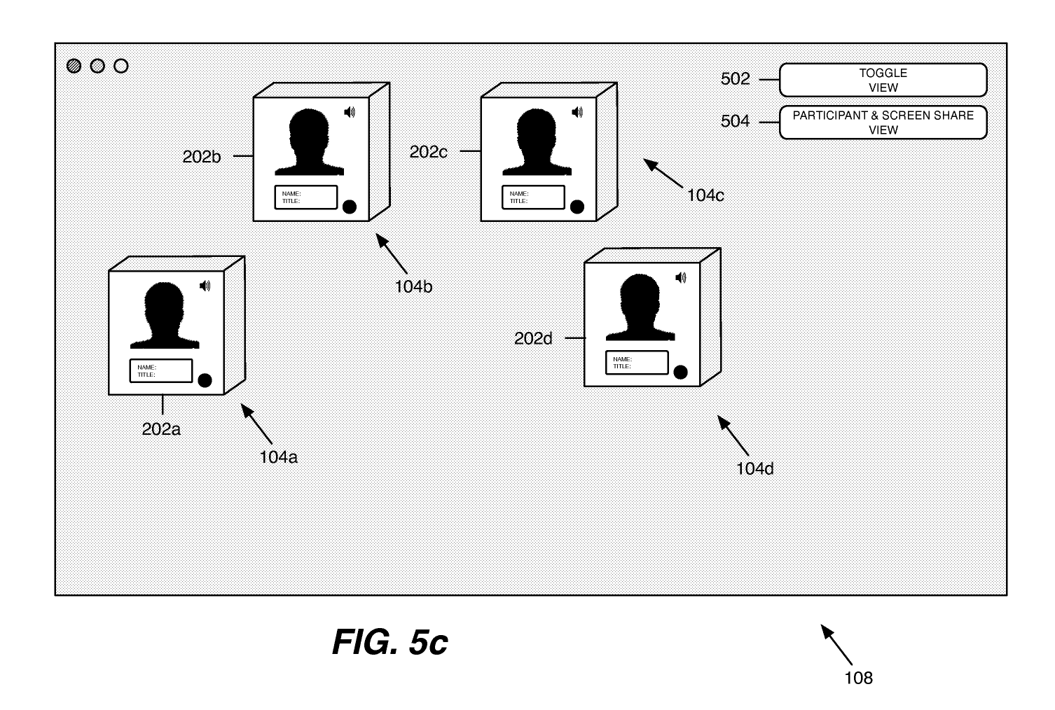

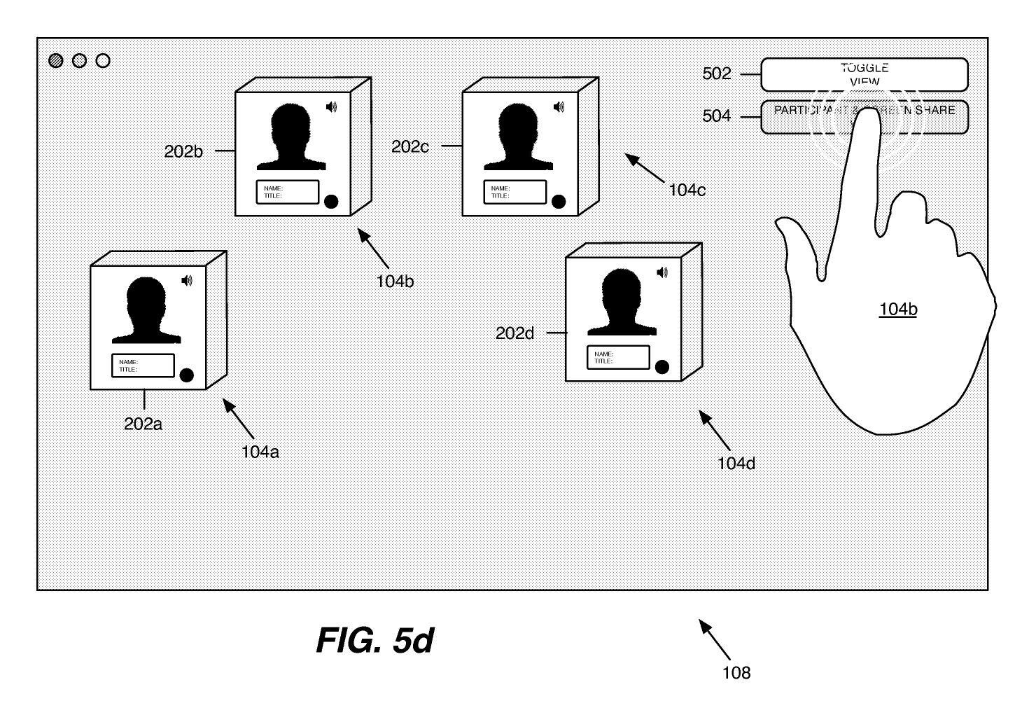

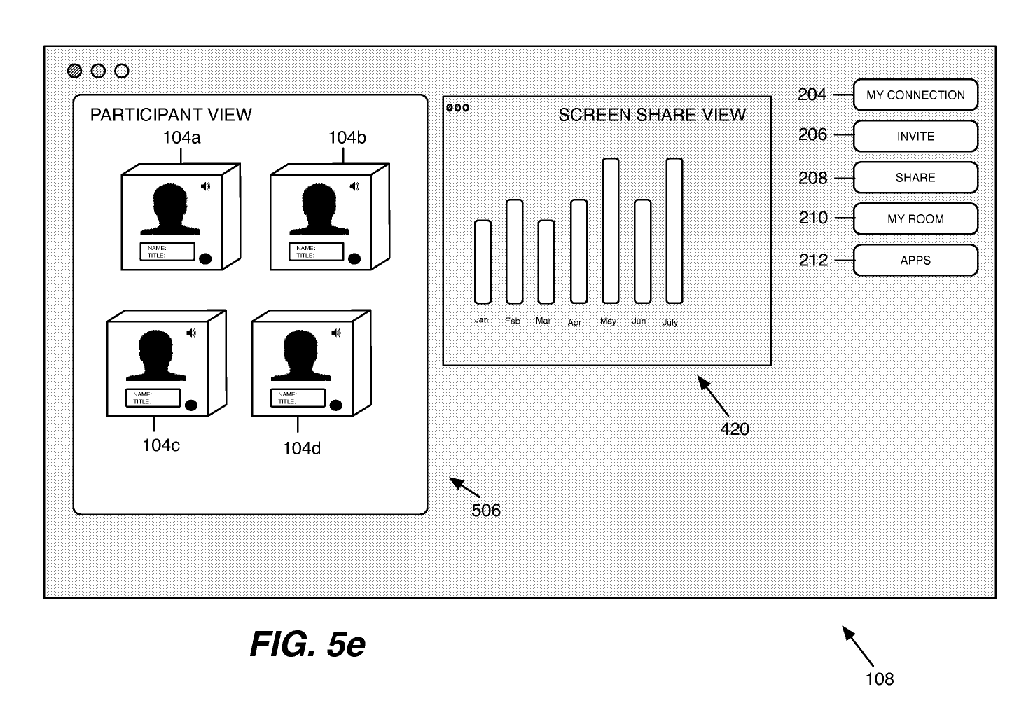

The sharing participant 104a may share any content, functionality, applications, etc. (collectively referred to as “content” or “shared content”) available on the desktop 400 or a remote location. In the desktop environment on the sharing participant's computing device 102, the conference user interface 108 may be minimized as a window 108 with other active windows (e.g., a browser window 422, a presentation application window 420). The shared content may be presented to the viewing participants 104b, 104c, and 104d in any desirable manner. FIGS. 5a-5e illustrate an exemplary embodiment of a screen sharing view 122 presented to the viewing participants in a user interface 420. It should be appreciated that the screen sharing view 122 may be integrated with the conference user interface 108 (e.g., as a display region) or otherwise presented separately via a graphical user interface. In the example of FIGS. 5a-5e, the shared content comprises the presentation application window 420 from the sharing participant's computing device 102.

The screen sharing view 122 may comprise user interface controls for enabling the viewing participants to selectively control the presentation views. In an embodiment, the screen sharing view 122 may comprise a toggle view component 502 and a participant & screen share view. A viewing participant 104b may select the toggle view component 502 (FIG. 5b), which sends a request to the conferencing system 106 (or the operating system of the computing device 102) to toggle between the screen share view 122 and the participant view 120 (FIG. 5c). It should be appreciated that the toggle operation may be controlled via any suitable input command, such as, for example voice commands or a hotkey (e.g., predetermined keystroke(s)). When in either the participant view 120, the screen share view 122, or the conference user interface 108, the viewing participant 104b may select the participant & screen share view component 504 (FIG. 5d), which initiates the simultaneous presentation of both the participant view 120 and the screen share view 122 (FIG. 5e) in display regions 506 and 420, respectively.

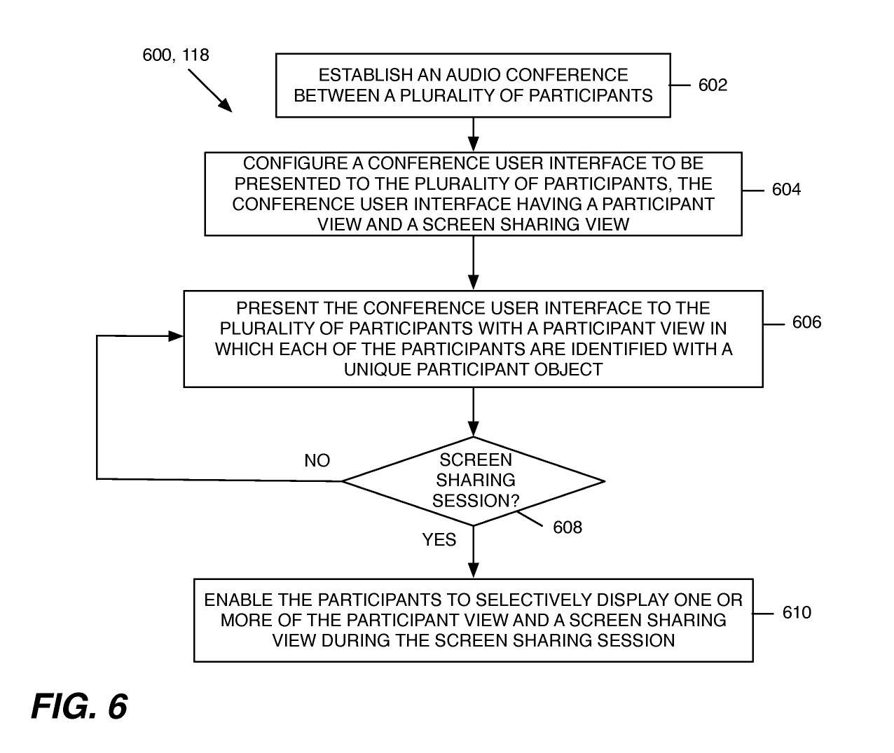

FIG. 6 illustrates the architecture, operation, and/or functionality of the view selector module(s) 118. The logic associated with the view selector module(s) 118 are illustrated in FIG. 1 as being located at the conferencing system 106. However, it should be appreciated that aspects of the logic may reside at the conferencing system 106, server(s) associated with the conferencing system 106, or the computing device(s) 102. At block 602, the conferencing system 106 establishes an audio conference 112 between a plurality of participants 104 via associated computing devices 102 connected to the conferencing system via communication network(s) 110. At block 604, the conferencing system configures the conference user interface 108 to be presented to the plurality of participants 104. The conference user interface 108 comprises a participant view 120 and a screen sharing view 122. At block 604, the conferencing system 106 presents the conference user interface 108 to one or more participants during at least a portion of the audio conference 112. The conference user interface 108 may default to the participant view 120 in which the participants 104 are graphically identified with a corresponding unique participant object 202. At decision block 608, the conferencing system 106 and/or the sharing participant's computing device 102 determine that a screen sharing session has been initiated. During the screen sharing session, the conferencing system 106 enables the viewing participants and/or the sharing participant to selectively display one or more of the participant view 120 and the screen sharing view 122, as indicated in block 610.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the multi-platform virtual conference location system. Furthermore, the logical functions may be embodied in any computer readable medium for use by or in connection with an instruction execution system, apparatus, or device, such as a computer-based system, processor-containing system, or other system associated with the multi-platform virtual conference location system that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for controlling presentation views in an online conference, the method comprising:
a conferencing system establishing an audio conference, via a communication network, between a plurality of participants;
the conferencing system configuring a conference user interface to be presented to the plurality of participants via a corresponding client device in communication with the conference system via the communication network, the conference user interface having a participant view in which each of the plurality of participants are identified with a unique participant object having a graphical representation specified by the corresponding participant and a screen sharing view in which content presented in a first screen of a first client device associated with a first participant may be simultaneously presented in a second screen of a second client device associated with a second participant during a screen sharing session; and
the conference user interface enabling the participants to selectively display one or more of the participant view and the screen sharing view during the screen sharing session.

2. The method of claim 1, wherein the conference user interface enabling the participants to selectively display the participant view and the screen sharing view comprises the conferencing system simultaneously displaying the participant view and the screen sharing view to at least one of the participants.

3. The method of claim 1, wherein the conference user interface enabling the participants to selectively display the participant view and the screen sharing view comprises presenting a view selector component via the conference user interface.

4. The method of claim 3, wherein the view selector component comprises one of a hotkey and a selectable user interface button displayed in the conference user interface.

5. The method of claim 4, wherein the view selector component toggles between the participant view and the screen sharing view.

6. The method of claim 1, further comprising:
displaying a view selector component in the conference user interface presented to the second client device;
the second participant selecting via the view selector component the screen sharing view as an active view;
the conferencing system receiving the participant selection; and
the conferencing system displaying the screen sharing view as the active view for the second participant.

7. The method of claim 1, wherein the graphical representation comprises one or more of a two-dimensional graphic, a three-dimensional graphic, an avatar, an icon, or a video.

8. The method of claim 1, wherein the graphical representation is selected from a predefined list of default images.

9. The method of claim 1, wherein the unique participant object comprises an interactive object having a plurality of selectable display faces.

10. The method of claim 9, further comprising:
displaying the graphical representation in a first selectable display face; and
displaying a participant profile in a second selectable display face; and
displaying a social networking feed corresponding to the participant in a third selectable display face.

11. The method of claim 1, wherein the participant view further comprises a simulated location view.

12. A computer system comprising:
a conferencing system for establishing an audio conference between a plurality of participants via a communication network; and
a server configured to communicate with the conferencing system and the plurality of computing devices via the communication network, the server comprising a processor, a memory, and a view selector module stored in the memory and executed by the processor, the view selector module comprising:
logic configured to present a conference user interface to the plurality of participants via a corresponding client device in communication with the server via the communication network, the conference user interface having a participant view in which each of the plurality of participants are identified with a unique participant object having a graphical representation of the corresponding participant and a screen sharing view in which a first screen of a first client device associated with a first participant may be shared with a second screen of a second client device associated with a second participant during a screen sharing session; and
logic configured to enable the participants to selectively control presentation of one or more of the participant view and the screen sharing view during the screen sharing session.

13. The computer system of claim 12, wherein the logic configured to enable the participants to selectively control presentation of the participant view and the screen sharing view comprises the logic configured to simultaneously display the participant view and the screen sharing view to at least one of the participants.

14. The computer system of claim 12, wherein the view selector module further comprises logic configured to present a view selector component via the conference user interface.

15. The computer system of claim 14, wherein the view selector component comprises one of a hotkey and a selectable user interface button displayed in the conference user interface.

16. The computer system of claim 15, wherein the view selector component toggles between the participant view and the screen sharing view.

17. The computer system of claim 12, wherein the view selector module further comprises:
logic configured to display a view selector component in the conference user interface presented to the second client device;
logic configured to receive via the view selector component from the second participant one of the participant view and the screen sharing view as an active view; and
logic configured to present the active view to the second client device.

18. The computer system of claim 12, wherein the unique participant object comprises an interactive object having a plurality of selectable display faces.

19. The computer system of claim 18, wherein the view selector module further comprises: logic configured to display, for each unique participant object:
the corresponding graphical representation in a first selectable display face;
a participant profile in a second selectable display face; and
a social networking feed corresponding to the participant in a third selectable display face.

20. The computer system of claim 12, wherein the participant view further comprises a simulated location view.
